(19) United States
(12) Patent Application Publication
(10) Pub. No.: US 2009/0244805 A1
(43) Pub. Date: Oct. 1, 2009

(54) DIELECTRIC CERAMIC A ND MULTILAYER CERAMIC CAPACITOR

(75) Inventors: Koichi Banno, Yasu-shi (JP); Tomomi Koga, Yasu-shi (JP)

Correspondence Address: DICKSTEIN SHAPIRO LLP, 1633 Broadway, NEW YORK, NY, 10019, US

(73) Assignee: MURATA MANUFACTURING CO., LTD., Nagaokakyo-Shi (JP)

(21) Appl. No.: 12/484,750

(22) Filed: Jun. 15, 2009

Related U.S. Application Data
(63) Continuation of application No. PCT/JP2007/072509, filed on Nov. 21, 2007.

(30) Foreign Application Priority Data
Dec. 21, 2006 (JP) 2006-343809

(51) Int. Cl. H01G 4/30; C04B 35/00; H01G 4/008; H01G 4/12

(52) U.S. Cl. 361/301.4; 252/62.3 BT

(57) ABSTRACT

Provided is a dielectric ceramic in which, while achieving a dielectric constant ε of 500 or more, a breakdown voltage higher than 90 kV/mm can be obtained and which is suitable for constituting dielectric ceramic layers of a multilayer ceramic capacitor for medium-to-high voltage application. As the dielectric ceramic constituting dielectric ceramic layers of the multilayer ceramic capacitor, a dielectric ceramic including, as a main component, (Ba₁₋ₓCaₓ)ₘTiO₃ where 0.30≦x≦0.50, and 0.950≦m≦1.025 is used. Preferably, the dielectric ceramic further includes a rare-earth element in an amount of 1 to 14 parts by mole relative to 100 parts by mole of the main component, and further includes Mn, Mg, and Si, respectively, in amounts of 0.1 to 3.0 parts by mole, 0.5 to 5.0 parts by mole, and 1.0 to 5.0 parts by mole relative to 100 parts by mole of the main component.

This is a continuation of application Ser. No. PCT/JP2007/072509, filed Nov. 21, 2007.

### TECHNICAL FIELD

The present invention relates to dielectric ceramics and multilayer ceramic capacitors fabricated using the dielectric ceramics. More particularly, the invention relates to dielectric ceramics and multilayer ceramic capacitors suitable for use under high electric field.

### BACKGROUND ART

Some multilayer ceramic capacitors are used at a high voltage of, for example, 250 to 1,000 V. In such a case, the high voltage, corresponding to an electric field of 25 to 100 kV/mm, is applied to each dielectric ceramic layer. Therefore, in such multilayer ceramic capacitors used for medium-to-high voltage application, there is a possibility that dielectric breakdown may occur in dielectric ceramic layers.

As is evident from the background described above, the breakdown voltage (BDV; unit: kV/mm) can be an important index in multilayer ceramic capacitors used for medium-to-high voltage application. The term BDV refers to the value of electric field at which dielectric breakdown occurs when the electric field is increased. The BDV is a completely different phenomenon from “lifetime” as measured in a load test.

As a dielectric ceramic which is the subject of interest in the invention, for example, the dielectric ceramic described in Japanese Patent No. 3323801 (Patent Document 1) may be mentioned. Patent Document 1 discloses a (Ca, Sr, Ba) (Zr, Ti) O₃-based dielectric ceramic. This dielectric ceramic has reduction resistance, and an improvement in BDV is achieved while improving the linearity of the temperature characteristic of capacitance and the quality factor Q.

In general, materials having a high BDV have a low dielectric constant ε. The dielectric ceramic described in Patent Document 1 is no exception, and while a high BDV of 120 kV/mm or higher is achieved, the dielectric constant ε is low at about 100. This is disadvantageous considering the reduction in the size of multilayer ceramic capacitors.

Consequently, it is desired to develop dielectric ceramics in which both BDV and dielectric constant ε can be increased.

Patent Document 1: Japanese Patent No. 3323801

### DISCLOSURE OF INVENTION

### Problems to be Solved by the Invention

It is an object of the present invention to provide a dielectric ceramic which has both a high breakdown voltage and a high dielectric constant ε.

It is another object of the present invention to provide a multilayer ceramic capacitor which is fabricated using the dielectric ceramic and suitable for use in medium-to-high voltage application.

### Means for Solving the Problems

In order to solve the technical problems described above, a dielectric ceramic according to the present invention includes, as a main component, (Ba₁₋ₓCaₓ)ₘTiO₃ where 0.30≦x≦0.50, and 0.950≦m≦1.025.

Preferably, the dielectric ceramic further includes at least one rare-earth element selected from the group consisting of Y, La, Ce, Pr, Nd, Sm, Eu, Gd, Tb, Dy, Ho, Er, Tm, Yb, and Lu in an amount of 1 to 14 parts by mole relative to 100 parts by mole of the main component.

Preferably, the dielectric ceramic further includes Mn, Mg, and Si, respectively, in amounts of 0.1 to 3.0 parts by mole, 0.5 to 5.0 parts by mole, and 1.0 to 5.0 parts by mole relative to 100 parts by mole of the main component.

The present invention is also directed to a multilayer ceramic capacitor which includes a laminate including a plurality of stacked dielectric ceramic layers and internal electrodes extending along specific interfaces between the dielectric ceramic layers, and external electrodes disposed on the exterior surface of the laminate so as to be electrically connected to specific internal electrodes among the internal electrodes. In the multilayer ceramic capacitor according to the present invention, the internal electrodes preferably contain Ni as a main component, and the dielectric ceramic layers are composed of the dielectric ceramic according to the present invention.

The present invention is advantageously applied to a multilayer ceramic capacitor which is used in an electric field range of 25 to 100 kV/mm and which has a breakdown voltage higher than 90 kV/mm.

### Advantages

In the dielectric ceramic according to the present invention, BaₘTiO₃ and CaₘTiO₃ may not completely form a solid solution and may be separated into two phases. Here, BaₘTiO₃ alone has a low breakdown voltage, but a high dielectric constant ε. On the other hand, CaₘTiO₃ alone has a high breakdown voltage, but a low dielectric constant ε. By selecting x which represents the molar ratio therebetween so as to satisfy the condition 0.30≦x≦0.50, it is possible to bring out characteristics in which the advantages of both are combined due to the synergic effect instead of simply averaged. As a result, in the dielectric ceramic according to the present invention, a breakdown voltage higher than 90 kV/mm can be realized, for example, while achieving a dielectric constant ε of 500 or more.

When the dielectric ceramic according to the present invention further includes a predetermined amount of the rare-earth element as described above, the synergic effect between BaₘTiO₃ and CaₘTiO₃ can be further enhanced. For example, while achieving a dielectric constant ε of 500 or more, a breakdown voltage of 100 kV/mm or higher can be realized.

When the dielectric ceramic according to the present invention further includes the predetermined amounts of Mn, Mg, and Si as described above, it is possible to obtain the dielectric constant ε and the breakdown voltage even by firing in a reducing atmosphere. Consequently, even in a multilayer ceramic capacitor including internal electrodes containing Ni as a main component, high reliability can be ensured.

### BRIEF DESCRIPTION OF DRAWINGS

FIG. 1 is a cross-sectional view schematically showing a multilayer ceramic capacitor 1 according to an embodiment of the present invention.

### REFERENCE NUMERALS

1 Multilayer ceramic capacitor

2 laminate

3 dielectric ceramic layer

4, 5 internal electrode

8, 9 external electrode

### BEST MODES FOR CARRYING OUT THE INVENTION

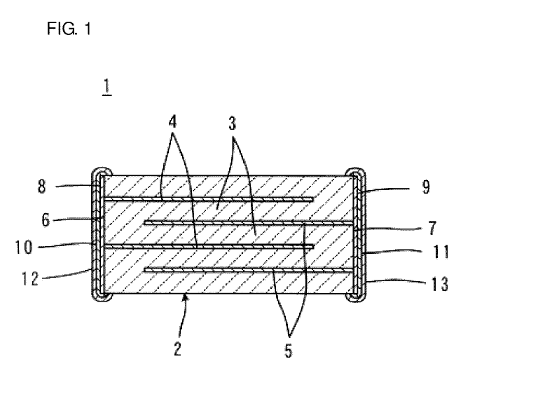

FIG. 1 is a cross-sectional view showing a multilayer ceramic capacitor 1 according to an embodiment of the present invention.

The multilayer ceramic capacitor 1 includes a laminate 2. The laminate 2 includes a plurality of stacked dielectric ceramic layers 3 and a plurality of internal electrodes 4 and 5 extending along specific interfaces between the plurality of dielectric ceramic layers 3.

The internal electrodes 4 and 5 preferably contain Ni as a main component. The internal electrodes 4 and 5 are disposed so as to extend to the exterior surface of the laminate 2. The internal electrodes 4 extending to one end face 6 and the internal electrodes 5 extending to another end face 7 are alternately arranged inside the laminate 2.

External electrodes 8 and 9 are disposed on the exterior surface of the laminate 2 and on the end faces 6 and 7, respectively. The external electrodes 8 and 9 are formed, for example, by applying a conductive paste containing Cu as a main component, followed by baking. The external electrode 8 is electrically connected to the internal electrodes 4 on the end face 6, and the external electrode 9 is electrically connected to the internal electrodes 5 on the end face 7.

In order to improve solderability, as necessary, first plating films 10 and 11 composed of Ni or the like, and further thereon second plating films 12 and 13 composed of Sn or the like are disposed on the external electrodes 8 and 9, respectively.

In the multilayer ceramic capacitor 1, the dielectric ceramic layers 3 are composed of the dielectric ceramic according to the present invention, i.e., the dielectric ceramic including, as a main component, (Ba₁₋ₓCaₓ)ₘTiO₃ (0.30≦x≦0.50, 0.950≦m≦1.025).

In (Ba₁₋ₓCaₓ)ₘTiO₃, which is the main component of the dielectric ceramic, BaₘTiO₃ and CaₘTiO₃ may not completely form a solid solution and may be separated into two phases. Here, BaₘTiO₃ alone has a low breakdown voltage (BDV), but a high dielectric constant ε. On the other hand, CaₘTiO₃ alone has a high BDV, but a low ε. It has been found that by selecting x which represents the molar ratio therebetween so as to satisfy the condition 0.30≦x≦0.50 as described above, it is possible to bring out characteristics in which the advantages of both are combined due to the synergic effect instead of averaging between BaₘTiO₃ and CaₘTiO₃. For example, while achieving an ε of 500 or more, a BDV of 120 kV/mm or higher can be realized, and a BDV higher than 90 kV/mm can be obtained at a minimum.

Preferably, the dielectric ceramic constituting the dielectric ceramic layers 3 further includes at least one rare-earth element selected from the group consisting of Y, La, Ce, Pr, Nd, Sm, Eu, Gd, Tb, Dy, Ho, Er, Tm, Yb, and Lu in an amount of 1 to 14 parts by mole relative to 100 parts by mole of the main component. Such rare-earth elements have an effect of increasing the synergic effect due to BaₘTiO₃ and CaₘTiO₃ described above, and by adding a predetermined amount of the rare-earth element, it is possible to improve the achievement of both a high BDV and a high ε. More specifically, for example, while achieving an ε of 500 or more, a BDV of 140 kV/mm or higher can be realized, and thus a BDV of 100 kV/mm or higher can be obtained at a minimum.

Preferably, the dielectric ceramic constituting the dielectric ceramic layers 3 further includes Mn, Mg, and Si, respectively, in amounts of 0.1 to 3.0 parts by mole, 0.5 to 5.0 parts by mole, and 1.0 to 5.0 parts by mole relative to 100 parts by mole of the main component. When the predetermined amounts of Mn, Mg, and Si are incorporated as described above, even in a multilayer ceramic capacitor 1 including internal electrodes 4 containing Ni as a main component, a high BDV and a high ε can be obtained, and high reliability can be ensured.

In the case where, in addition to the main component composed of (Ba₁₋ₓCaₓ)ₘTiO₃, at least one rare-earth element and/or Mn, Mg, and Si are incorporated into the dielectric ceramic constituting the dielectric ceramic layers 3, in addition to BaₘTiO₃ powder and CaₘTiO₃ powder, powder of oxide(s), carbonate(s), or the like of rare-earth element(s) and/or powder of oxides, carbonates, or the like of Mn, Mg, and Si are added to the slurry prepared for forming ceramic green sheets to be formed into the dielectric ceramic layers 3.

In the dielectric ceramic according to the present invention, Ba and Ca may be replaced, in an amount of 5 mole percent or less, with Sr, and Ti may be replaced, in an amount of 5 mole percent or less, with Zr and/or Hf.

Examples of experiments carried out in order to confirm the advantages of the present invention will now be described.

### EXPERIMENTAL EXAMPLE 1

First, as starting materials for the main component, BaₘTiO₃ powder and CaₘTiO₃ powder synthesized by a solid phase method were prepared. Furthermore, as starting materials for the sub-components, powders of oxides of rare-earth elements, such as Y₂O₃, La₂O₃, CeO₂, Pr₆O₁₁, Nd₂O₃, Sm₂O₃, Eu₂O₃, Gd₂O₃, Tb₂O₃, Ho₂O₃, Er₂O₃, Tm₂O₃, Yb₂O₃, and Lu₂O₃, were prepared, and also powder of each of MgO, MnO, and SiO₂ was prepared.

Next, the BaₘTiO₃ powder and the CaₘTiO₃ powder prepared as described above were weighed so as to satisfy the compositions shown in Table 1, and the powders were mixed. Furthermore, powders of starting materials for the sub-components were added so as to satisfy the compositions shown in Table 1. In Table 1, the amounts of addition of powders of oxides of the rare-earth element, Mg, Mn, and Si are shown in terms of parts by mole relative to 100 parts by mole of the main component. Next, each of the mixed powders was mixed in water with a ball mill, using PSZ media with a diameter of 2 mm, for 16 hours. Thereby, a thoroughly dispersed slurry was obtained. The resulting slurry was dried to obtain a dielectric ceramic raw material powder.

TABLE 1

| | | | Rare-earth | | | | |
|---|---|---|---|---|---|---|---|
| | | | element | | | | |
| | | | | Amount | Mg | Mn | Si |
| | | | | [Parts | [Parts | [Parts | [Parts |
| Sample | (Ba₁₋ₓCaₓ)ₘTiO₃ | | | by | by | by | by |
| No. | x | m | Type | mole] | mole] | mole] | mole] |
| 1 | 0.25 | 1.005 | — | 0 | 1.0 | 0.5 | 1.5 |
| 2 | 0.30 | 1.005 | — | 0 | 1.0 | 0.5 | 1.5 |
| 3 | 0.35 | 1.005 | — | 0 | 1.0 | 0.5 | 1.5 |
| 4 | 0.45 | 1.005 | — | 0 | 1.0 | 0.5 | 1.5 |
| 5 | 0.50 | 1.005 | — | 0 | 1.0 | 0.5 | 1.5 |
| 6 | 0.60 | 1.005 | — | 0 | 1.0 | 0.5 | 1.5 |
| 7 | 0.25 | 1.005 | Dy | 5 | 1.0 | 0.5 | 1.5 |
| 8 | 0.30 | 1.005 | Dy | 5 | 1.0 | 0.5 | 1.5 |
| 9 | 0.35 | 1.005 | Dy | 5 | 1.0 | 0.5 | 1.5 |
| 10 | 0.45 | 1.005 | Dy | 5 | 1.0 | 0.5 | 1.5 |
| 11 | 0.50 | 1.005 | Dy | 5 | 1.0 | 0.5 | 1.5 |
| 12 | 0.60 | 1.005 | Dy | 5 | 1.0 | 0.5 | 1.5 |
| 13 | 0.40 | 1.005 | Dy | 1 | 1.0 | 0.5 | 1.5 |
| 14 | 0.40 | 1.005 | Dy | 3 | 1.0 | 0.5 | 1.5 |
| 15 | 0.40 | 1.005 | Dy | 8 | 1.0 | 0.5 | 1.5 |
| 16 | 0.40 | 1.005 | Dy | 11 | 1.0 | 0.5 | 1.5 |
| 17 | 0.40 | 1.005 | Dy | 14 | 1.0 | 0.5 | 1.5 |
| 18 | 0.40 | 0.900 | Dy | 5 | 1.0 | 0.5 | 1.5 |
| 19 | 0.40 | 0.950 | Dy | 5 | 1.0 | 0.5 | 1.5 |
| 20 | 0.40 | 1.025 | Dy | 5 | 1.0 | 0.5 | 1.5 |
| 21 | 0.40 | 1.030 | Dy | 5 | 1.0 | 0.5 | 1.5 |
| 22 | 0.40 | 1.005 | Dy | 5 | 0.0 | 0.5 | 1.5 |
| 23 | 0.40 | 1.005 | Dy | 5 | 0.5 | 0.5 | 1.5 |
| 24 | 0.40 | 1.005 | Dy | 5 | 5.0 | 0.5 | 1.5 |
| 25 | 0.40 | 1.005 | Dy | 5 | 6.0 | 0.5 | 1.5 |
| 26 | 0.40 | 1.005 | Dy | 5 | 1.0 | 0.0 | 1.5 |
| 27 | 0.40 | 1.005 | Dy | 5 | 1.0 | 0.1 | 1.5 |
| 28 | 0.40 | 1.005 | Dy | 5 | 1.0 | 3.0 | 1.5 |
| 29 | 0.40 | 1.005 | Dy | 5 | 1.0 | 4.0 | 1.5 |
| 30 | 0.40 | 1.005 | Dy | 5 | 1.0 | 0.5 | 0.0 |
| 31 | 0.40 | 1.005 | Dy | 5 | 1.0 | 0.5 | 1.0 |
| 32 | 0.40 | 1.005 | Dy | 5 | 1.0 | 0.5 | 5.0 |
| 33 | 0.40 | 1.005 | Dy | 5 | 1.0 | 0.5 | 6.0 |
| 34 | 0.40 | 1.005 | Y | 5 | 1.0 | 0.5 | 1.5 |
| 35 | 0.40 | 1.005 | La | 5 | 1.0 | 0.5 | 1.5 |
| 36 | 0.40 | 1.005 | Ce | 5 | 1.0 | 0.5 | 1.5 |
| 37 | 0.40 | 1.005 | Pr | 5 | 1.0 | 0.5 | 1.5 |
| 38 | 0.40 | 1.005 | Nd | 5 | 1.0 | 0.5 | 1.5 |
| 39 | 0.40 | 1.005 | Sm | 5 | 1.0 | 0.5 | 1.5 |
| 40 | 0.40 | 1.005 | Eu | 5 | 1.0 | 0.5 | 1.5 |
| 41 | 0.40 | 1.005 | Gd | 5 | 1.0 | 0.5 | 1.5 |
| 42 | 0.40 | 1.005 | Tb | 5 | 1.0 | 0.5 | 1.5 |
| 43 | 0.40 | 1.005 | Ho | 5 | 1.0 | 0.5 | 1.5 |
| 44 | 0.40 | 1.005 | Er | 5 | 1.0 | 0.5 | 1.5 |
| 45 | 0.40 | 1.005 | Tm | 5 | 1.0 | 0.5 | 1.5 |
| 46 | 0.40 | 1.005 | Yb | 5 | 1.0 | 0.5 | 1.5 |
| 47 | 0.40 | 1.005 | Lu | 5 | 1.0 | 0.5 | 1.5 |

Next, a polyvinyl butyral-based binder and ethanol were added to each of the raw material powders, and mixing was performed using a ball mill. A ceramic slurry was thereby prepared. The ceramic slurry was formed into sheets by a doctor blade process, and thereby, ceramic green sheets were obtained.

Next, a conductive paste mainly composed of Ni was applied onto the ceramic green sheets by screen printing, and thereby, conductive paste films to be formed into internal electrodes were formed. Eleven ceramic green sheets provided with the conductive paste films were stacked in such a manner that the conductive paste films were alternately extended to either end face, and a green laminate was thereby obtained.

Next, the green laminate was heated to 300° C. in a nitrogen atmosphere to burn the binder, and then firing was performed for 2 hours at 1,250° C. in a reducing atmosphere composed of H₂—N₂—H₂O gas thereby to obtain a sintered laminate. The sintered laminate includes dielectric layers obtained by sintering of the ceramic green sheets and internal electrodes obtained by sintering of the conductive paste films.

Next, a conductive paste containing a glass frit and mainly composed of Cu was applied to both end faces of the laminate, and baking was performed at 800° C. in a nitrogen atmosphere. Thereby, external electrodes which were electrically connected to the internal electrodes were formed. A Ni plating film and a Sn plating film were further formed on each of the external electrodes. A multilayer ceramic capacitor was thereby obtained for each sample.

Each multilayer ceramic capacitor thus obtained had outer dimensions of 2.0 mm in length, 1.2 mm in width, and 0.5 mm in thickness, and the thickness of the dielectric ceramic layers disposed between the internal electrodes was 10 μm. The number of effective dielectric ceramic layers for forming capacitance was 10, and the facing electrode area per one dielectric ceramic layer was 1.3 mm².

In the multilayer ceramic capacitor for each sample, the dielectric constant ε of the dielectric ceramic constituting the dielectric ceramic layers was calculated from the capacitance of the multilayer ceramic capacitor measured under the conditions of 25° C., 1 kHz, and 1 Vᵣₘₛ. Furthermore, the resistivity ρ of the dielectric ceramic constituting the dielectric ceramic layers was calculated from the insulation resistance measured after charging at 300 V at 25° C. for 60 seconds. Furthermore, the BDV (average value) was obtained by applying a DC voltage at a voltage elevation rate of 50 V/sec to the Multilayer ceramic capacitor.

The dielectric constant ε, log ρ, and BDV thus obtained are shown in Table 2. Table 2 also shows ε×(BDV)² as an index making it possible to quantitatively measure the compatibility between the dielectric constant ε and the BDV.

TABLE 2

| Sample | | BDV | | log ρ |
|---|---|---|---|---|
| No. | ε | [kV/mm] | ε × (BDV)² | [ρ:Ωm] |
| 1 | 1500 | 80 | 0.96 | 11.7 |
| 2 | 1000 | 140 | 1.96 | 11.7 |
| 3 | 950 | 140 | 1.86 | 11.5 |
| 4 | 750 | 150 | 1.69 | 11.3 |
| 5 | 650 | 155 | 1.56 | 11.2 |
| 6 | 400 | 155 | 0.96 | 11.0 |
| 7 | 1800 | 90 | 1.46 | 11.0 |
| 8 | 1600 | 170 | 4.62 | 11.0 |
| 9 | 1400 | 170 | 4.05 | 10.8 |
| 10 | 1000 | 170 | 2.89 | 10.6 |
| 11 | 800 | 180 | 2.59 | 10.5 |
| 12 | 400 | 180 | 1.30 | 10.3 |
| 13 | 900 | 140 | 1.76 | 11.2 |
| 14 | 1200 | 150 | 2.70 | 10.7 |
| 15 | 1000 | 170 | 2.89 | 10.5 |
| 16 | 800 | 170 | 2.31 | 10.3 |
| 17 | 600 | 170 | 1.73 | 10.2 |
| 18 | — | — | — | 8.5 |
| 19 | 1000 | 160 | 2.56 | 10.1 |
| 20 | 980 | 160 | 2.51 | 10.0 |
| 21 | — | — | — | 8.5 |
| 22 | — | — | — | 8.5 |
| 23 | 1500 | 160 | 3.84 | 10.5 |
| 24 | 1000 | 170 | 2.89 | 10.5 |
| 25 | — | — | — | 8.5 |
| 26 | — | — | — | 8.5 |
| 27 | 1200 | 170 | 3.47 | 10.3 |
| 28 | 1100 | 170 | 3.18 | 10.0 |
| 29 | 1000 | 180 | 3.24 | 9.5 |
| 30 | — | — | — | 8.5 |
| 31 | 1300 | 170 | 3.76 | 10.5 |
| 32 | 1000 | 170 | 2.89 | 10.0 |
| 33 | — | — | — | 8.5 |
| 34 | 1350 | 170 | 3.90 | 10.8 |
| 35 | 1400 | 170 | 4.05 | 10.9 |
| 36 | 1250 | 170 | 3.61 | 10.7 |
| 37 | 1400 | 170 | 4.05 | 10.8 |
| 38 | 1300 | 170 | 3.76 | 10.8 |
| 39 | 1350 | 170 | 3.90 | 10.8 |
| 40 | 1180 | 170 | 3.41 | 10.7 |
| 41 | 1220 | 170 | 3.53 | 10.9 |
| 42 | 1290 | 170 | 3.73 | 10.8 |
| 43 | 1410 | 170 | 4.07 | 10.8 |
| 44 | 1360 | 170 | 3.93 | 10.8 |
| 45 | 1340 | 170 | 3.87 | 10.9 |
| 46 | 1290 | 170 | 3.73 | 10.8 |
| 47 | 1300 | 170 | 3.76 | 10.7 |

As shown in Table 1, the BaₘTiO₃/CaₘTiO₃ ratio is changed in the compositions of Sample Nos. 1 to 6, which do not contain a rare-earth element. In Sample Nos. 2 to 5 in which x is in the range of 0.30 to 0.50, ε is 500 or more, and the BDV is 120 kV/mm or higher. Thus, a BDV higher than 90 kV/mm, which is the standard for medium-to-high voltage application, is obtained. In contrast, since x is less than 0.30 in Sample No. 1, the BDV is 80 kV/mm, and it is not possible to obtain a value higher than 90 kV/mm, which is the standard for medium-to-high voltage application. In Sample No. 6, ε is less than 500, which is disadvantageous considering the reduction in the size of multilayer ceramic capacitors.

In Sample Nos. 7 to 12, the effect of addition of Dy as the rare-earth element is evaluated while comparing with Sample Nos. 1 to 6. In Sample Nos. 7 to 12, both ε and the BDV are improved compared with Sample Nos. 1 to 6, which is significantly shown in ε×(BDV)². Furthermore, when x is out of the range of 0.30 to 0.50, as shown in Sample Nos. 7 and 12, the effect of addition of the rare-earth element is significantly small.

In Sample Nos. 13 to 17, the effect due to the amount of addition is evaluated by changing the amount of addition of the rare-earth element Dy. When the amount of addition of the rare-earth element is in the range of 1 to 14 parts by mole, ε and BDV that are equal to or high than those in Sample Nos. 2 to 5 which do not contain the rare-earth element are obtained.

In Sample Nos. 18 to 21, m is changed. In Sample Nos. and 21 in which m is out of the range of 0.950 to 1.025, sinterability is degraded, and ρ is degraded, which is not practical.

In Sample Nos. 22 to 33, the amount of addition of Mg, Mn, or Si is changed. In Sample Nos. 22 and 25 in which the amount of addition of Mg is out of the range of 0.5 to 5.0 parts by mole, Sample Nos. 20 and 29 in which the amount of addition of Mn is out of the range of 0.1 to 3.0 parts by mole, and Sample Nos. 30 and 33 in which the amount of addition of Si is out of the range of 1.0 to 5.0 parts by mole, ρ is degraded, which is not practical.

In Sample Nos. 34 to 47, it is confirmed that rare-earth elements other than Dy can also be used.

### EXPERIMENTAL EXAMPLE 2

In Experimental Example 2, experiments were carried out in the case where the method of mixing the staring materials was changed while using the same composition as that in Experimental Example 1 for each sample. That is, Sample Nos. 101 to 147 fabricated in Experimental Example 2 have the same compositions as those of Sample Nos. 1 to 47 in Experimental Example 1.

First, as starting materials for the main component, BaCO₃ powder, CaCO₃ powder, and TiO₂ powder were prepared. Furthermore, as starting materials for the sub-components, powders of oxides of rare-earth elements, such as Y₂O₃, La₂O₃, CeO₂, Pr₆O₁₁, Nd₂O₃, Sm₂O₃, Eu₂O₃, Gd₂O₃, Tb₂O₃, Ho₂O₃, Er₂O₃, Tm₂O₃, Yb₂O₃, and Lu₂O₃, were prepared, and also powder of each of MgO, MnO, and SiO₂ was prepared.

Next, the BaCO₃ powder, the TiO₂ powder, the powders of oxides of rare-earth elements, and the MgO powder only were weighed, and prepared powder A was obtained. Similarly, the CaCO₃ powder, the TiO₂ powder, the powders of oxides of rare-earth elements, and the MgO powder only were weighed, and prepared powder B was obtained. In this step, the ratio between the Ba component of the prepared powder A and the Ca component of the prepared powder B was set so as to satisfy the x value shown in Table 1 in Experimental Example 1. The content of the Ti component in the prepared powder A or B was set so as to satisfy the m value shown in Table 1 in Experimental Example 1 with reference to the Ba component or the Ca component. The contents of the rare-earth component and the Mg component were also divided in the prepared powder A and B so as to be the same as in Experimental Example 1.

Next, each of the prepared powders A and B was mixed in water with a ball mill, using PSZ media with a diameter of 2 mm, for 16 hours. Thereby, thoroughly dispersed slurries A and B were obtained. The slurries A and B were dried and calcined at a temperature of 900° C. to 1,100° C., thereby to obtain calcined powders A and B.

Next, the calcined powders A and B were mixed, and the powders of MnO and SiO₂ as the sub-components were added thereto so as to realize the same compositions as those in Experimental Example 1. Each of the mixed powders was mixed in water with a ball mill, using PSZ media with a diameter of 2 mm, for 16 hours. Thereby, a thoroughly dispersed slurry was obtained. The resulting slurry was dried to obtain a dielectric ceramic raw material powder for each sample.

Using the dielectric ceramic raw material powders for the individual samples, multilayer ceramic capacitors in Sample Nos. 101 to 147 were obtained through the same fabrication steps as those in Experimental Example 1. With respect to the multilayer ceramic capacitor for each sample, the same items as those in Experimental Example 1 were evaluated. The results thereof are shown in Table 3.

TABLE 3

| Sample | | BDV | | log ρ |
|---|---|---|---|---|
| No. | ε | [kV/mm] | ε × (BDV)² | [ρ:Ωm] |
| 101 | 1700 | 80 | 0.00 | 11.9 |
| 102 | 1100 | 155 | 0.00 | 11.8 |
| 103 | 1000 | 160 | 0.00 | 11.9 |
| 104 | 800 | 170 | 0.00 | 11.6 |
| 105 | 700 | 165 | 0.00 | 11.5 |
| 106 | 420 | 156 | 0.00 | 11.0 |
| 107 | 1950 | 90 | 0.00 | 11.6 |
| 108 | 1750 | 180 | 0.00 | 11.8 |
| 109 | 1550 | 185 | 0.00 | 11.0 |
| 110 | 1000 | 190 | 0.00 | 11.1 |
| 111 | 900 | 200 | 0.00 | 10.9 |
| 112 | 500 | 195 | 0.00 | 10.5 |
| 113 | 1000 | 160 | 0.00 | 11.6 |
| 114 | 1300 | 165 | 0.00 | 11.2 |
| 115 | 1100 | 175 | 0.00 | 10.9 |
| 116 | 700 | 180 | 0.00 | 10.8 |
| 117 | 500 | 175 | 0.00 | 10.4 |
| 118 | — | — | — | 8.0 |
| 119 | 1100 | 180 | 0.00 | 10.6 |
| 120 | 1020 | 175 | 0.00 | 10.8 |
| 121 | — | — | — | — |
| 122 | — | — | — | 8.3 |
| 123 | 1600 | 175 | 0.00 | 10.9 |
| 124 | 1200 | 175 | 0.00 | 10.9 |
| 125 | — | — | — | 8.8 |
| 126 | — | — | — | 8.1 |
| 127 | 1350 | 185 | 0.00 | 10.6 |
| 128 | 1150 | 190 | 0.00 | 10.8 |
| 129 | 1100 | 210 | 0.00 | 9.0 |
| 130 | — | — | — | 8.2 |
| 131 | 1250 | 175 | 0.00 | 10.6 |
| 132 | 1080 | 180 | 0.00 | 10.8 |
| 133 | — | — | — | 7.8 |
| 134 | 1200 | 180 | 0.00 | 10.5 |
| 135 | 1300 | 185 | 0.00 | 10.7 |
| 136 | 1250 | 180 | 0.00 | 10.5 |
| 137 | 1500 | 180 | 0.00 | 10.6 |
| 138 | 1250 | 180 | 0.00 | 10.2 |
| 139 | 1180 | 175 | 0.00 | 10.3 |
| 140 | 1200 | 180 | 0.00 | 10.5 |
| 141 | 1280 | 180 | 0.00 | 10.7 |
| 142 | 1350 | 180 | 0.00 | 10.9 |
| 143 | 1500 | 185 | 0.00 | 10.5 |
| 144 | 1350 | 180 | 0.00 | 10.3 |
| 145 | 1190 | 180 | 0.00 | 10.7 |
| 146 | 1200 | 175 | 0.00 | 10.6 |
| 147 | 1190 | 180 | 0.00 | 10.5 |

As is evident from comparison between Tables 3 and 2, with respect to the samples fabricated in Experimental Example 2, at least in the samples which are within the range of the present invention, large BDV values are obtained in comparison with Sample Nos. 1 to 47 fabricated in Experimental Example 1.

### EXPERIMENTAL EXAMPLE 3

In Experimental Example 3, experiments were carried out in the case where the method of mixing the staring materials was changed to a method different from that in Experimental Example 2, while using the same composition for each sample. Sample Nos. 201 to 247 fabricated in Experimental Example 3 have the same compositions as those of Sample Nos. 1 to 47 in Experimental Example 1.

First, as starting materials for the main component, BaCO₃ powder, CaCO₃ powder, and TiO₂ powder were prepared. Furthermore, as starting materials for the sub-components, powders of oxides of rare-earth elements, such as Y₂O₃, La₂O₃, CeO₂, Pr₆O₁₁, Nd₂O₃, Sm₂O₃, Eu₂O₃, Gd₂O₃, Tb₂O₃, Ho₂O₃, Er₂O₃, Tm₂O₃, Yb₂O₃, and Lu₂O₃, were prepared, and also powder of each of MgO, MnO, and SiO₂ was prepared.

Next, the BaCO₃ powder, the CaCO₃ powder, the TiO₂ powder, the powders of oxides of rare-earth elements, and the MgO powder only were weighed. Preparation was performed so as to satisfy the same compositions as those in Experimental Example 1 except for Mn and Si, and thereby, prepared powder was obtained.

The prepared powder was mixed in water with a ball mill, using PSZ media with a diameter of 2 mm, for 16 hours. Thereby, a thoroughly dispersed slurry was obtained. The slurry was dried and calcined at a temperature of 900° C. to 1,100° C., thereby to obtain calcined powder.

Next, powders of MnO and SiO₂ as the sub-components were added to the calcined powder so as to satisfy the same compositions as those in Experimental Example 1. Mixing was performed in water with a ball mill, using PSZ media with a diameter of 2 mm, for 16 hours. Thereby, a thoroughly dispersed slurry was obtained. The resulting slurry was dried to obtain a dielectric ceramic raw material powder for each sample.

Using the dielectric ceramic raw material powders for the individual samples, multilayer ceramic capacitors in Sample Nos. 201 to 247 were obtained through the same fabrication steps as those in Experimental Example 1. With respect to the multilayer ceramic capacitor for each sample, the same items as those in Experimental Example 1 were evaluated. The results thereof are shown in Table 4.

TABLE 4

| Sample | | BDV | | log ρ |
|---|---|---|---|---|
| No. | ε | [kV/mm] | ε × (BDV)² | [ρ:Ωm] |
| 201 | 1800 | 85 | 0.00 | 11.8 |
| 202 | 1250 | 160 | 0.00 | 11.4 |
| 203 | 1050 | 165 | 0.00 | 11.6 |
| 204 | 900 | 175 | 0.00 | 11.5 |
| 205 | 850 | 175 | 0.00 | 11.4 |
| 206 | 430 | 165 | 0.00 | 11.6 |
| 207 | 2000 | 90 | 0.00 | 11.5 |
| 208 | 1700 | 190 | 0.00 | 11.4 |
| 209 | 1340 | 190 | 0.00 | 11.0 |
| 210 | 850 | 195 | 0.00 | 11.0 |
| 211 | 900 | 250 | 0.00 | 10.7 |
| 212 | 530 | 200 | 0.00 | 10.2 |
| 213 | 980 | 165 | 0.00 | 11.1 |
| 214 | 1250 | 170 | 0.00 | 10.8 |
| 215 | 1080 | 180 | 0.00 | 10.4 |
| 216 | 800 | 185 | 0.00 | 10.6 |
| 217 | 600 | 180 | 0.00 | 10.1 |
| 218 | — | — | — | 7.8 |
| 219 | 1050 | 185 | 0.00 | 10.2 |
| 220 | 1100 | 180 | 0.00 | 10.4 |
| 221 | — | — | — | — |
| 222 | — | — | — | 8.0 |
| 223 | 1650 | 180 | 0.00 | 10.1 |
| 224 | 1300 | 185 | 0.00 | 10.5 |
| 225 | — | — | — | 8.3 |
| 226 | — | — | — | 8.0 |
| 227 | 1400 | 190 | 0.00 | 10.3 |
| 228 | 1200 | 195 | 0.00 | 10.7 |
| 229 | 1100 | 245 | 0.00 | 8.9 |
| 230 | — | — | — | 8.1 |
| 231 | 1200 | 180 | 0.00 | 10.6 |
| 232 | 1230 | 185 | 0.00 | 10.4 |
| 233 | — | — | — | 7.9 |
| 234 | 1150 | 185 | 0.00 | 10.3 |
| 235 | 1200 | 195 | 0.00 | 10.7 |
| 236 | 1200 | 190 | 0.00 | 10.3 |
| 237 | 1400 | 190 | 0.00 | 10.4 |
| 238 | 1300 | 185 | 0.00 | 10.0 |
| 239 | 1250 | 185 | 0.00 | 10.1 |
| 240 | 1180 | 190 | 0.00 | 10.6 |
| 241 | 1160 | 185 | 0.00 | 10.5 |
| 242 | 1260 | 185 | 0.00 | 10.7 |
| 243 | 1380 | 190 | 0.00 | 10.1 |
| 244 | 1410 | 185 | 0.00 | 10.0 |
| 245 | 1210 | 190 | 0.00 | 10.2 |
| 246 | 1190 | 185 | 0.00 | 10.3 |
| 247 | 1210 | 185 | 0.00 | 10.0 |

As is evident from comparison between Tables 4 and 2 with respect to the samples fabricated in Experimental Example 3, at least in the samples which are within the range of the present invention, large BDV values are obtained in comparison with Sample Nos. 1 to 47 fabricated in Experimental Example 1.

1. A dielectric ceramic comprising, as a main component, (Ba₁₋ₓCaₓ)ₘTiO₃ in which 0.30≦x≦0.50, 0.950≦m≦1.025, and in which 5 mole % or less of the (Ba₁₋ₓCaₓ) can be Sr, and 5 mole % of the Ti can be Zr, Hf or both.

2. The dielectric ceramic according to claim 1, wherein the amounts of Sr, Zr, Hf in the main component are 0 mole %.

3. The dielectric ceramic according to claim 2, further comprising at least one rare-earth element selected from the group consisting of Y, La, Ce, Pr, Nd, Sm, Eu, Gd, Tb, Dy, Ho, Er, Tm, Yb, and Lu in an amount of 1 to 14 parts by mole relative to 100 parts by mole of the main component.

4. The dielectric ceramic according to claim 3, further comprising Mn, Mg, and Si, in amounts of 0.1 to 3.0 parts by mole, 0.5 to 5.0 parts by mole, and 1.0 to 5.0 parts, respectively, by mole relative to 100 parts by mole of the main component.

5. The dielectric ceramic according to claim 2, further comprising Mn, Mg, and Si, in amounts of 0.1 to 3.0 parts by mole, 0.5 to 5.0 parts by mole, and 1.0 to 5.0 parts, respectively, by mole relative to 100 parts by mole of the main component.

6. A multilayer ceramic capacitor comprising:
a laminate including a plurality of stacked dielectric ceramic layers and a pair of internal electrodes extending along different interfaces between the dielectric ceramic layers; and
a pair of external electrodes disposed on the exterior surface of the laminate so as to be electrically connected to different ones of the pair of internal electrodes,
wherein the dielectric ceramic layers comprise the dielectric ceramic according to claim 5.

7. The multilayer ceramic capacitor according to claim 6, wherein the internal electrodes comprise Ni.

8. The multilayer ceramic capacitor according to claim 7, wherein the external electrodes comprise copper.

9. The multilayer ceramic capacitor according to claim 8, wherein the multilayer ceramic capacitor the breakdown voltage is higher than 90 kV/mm when in an electric field range of 25 to 100 kV/mm.

10. A multilayer ceramic capacitor comprising:
a laminate including a plurality of stacked dielectric ceramic layers and a pair of internal electrodes extending along different interfaces between the dielectric ceramic layers; and
a pair of external electrodes disposed on the exterior surface of the laminate so as to be electrically connected to different ones of the pair of internal electrodes,
wherein the dielectric ceramic layers comprise the dielectric ceramic according to claim 3.

11. The multilayer ceramic capacitor according to claim 10, wherein the internal electrodes comprise Ni.

12. The multilayer ceramic capacitor according to claim 11, wherein the external electrodes comprise copper.

13. The multilayer ceramic capacitor according to claim 12, wherein the multilayer ceramic capacitor the breakdown voltage is higher than 90 kV/mm when in an electric field range of 25 to 100 kV/mm.

13. The multilayer ceramic capacitor according to claim 12, wherein dielectric ceramic further comprises Mn, Mg, and Si, in amounts of 0.1 to 3.0 parts by mole, 0.5 to 5.0 parts by mole, and 1.0 to 5.0 parts, respectively, by mole relative to 100 parts by mole of the main component.

15. A multilayer ceramic capacitor comprising:
a laminate including a plurality of stacked dielectric ceramic layers and a pair of internal electrodes extending along different interfaces between the dielectric ceramic layers; and
a pair of external electrodes disposed on the exterior surface of the laminate so as to be electrically connected to different ones of the pair of internal electrodes,
wherein the dielectric ceramic layers comprise the dielectric ceramic according to claim 2.

16. The multilayer ceramic capacitor according to claim 15, wherein the internal electrodes comprise Ni.

17. The multilayer ceramic capacitor according to claim 16, wherein the external electrodes comprise copper.

18. The multilayer ceramic capacitor according to claim 17, wherein the multilayer ceramic capacitor the breakdown voltage is higher than 90 kV/mm when in an electric field range of 25 to 100 kV/mm.

10. A multilayer ceramic capacitor comprising:
a laminate including a plurality of stacked dielectric ceramic layers and a pair of internal electrodes extending along different interfaces between the dielectric ceramic layers; and
a pair of external electrodes disposed on the exterior surface of the laminate so as to be electrically connected to different ones of the pair of internal electrodes,
wherein the dielectric ceramic layers comprise the dielectric ceramic according to claim 1.

20. The multilayer ceramic capacitor according to claim 19, wherein the internal electrodes comprise Ni, and the external electrodes comprise copper.
